(19) United States
(12) Patent Application Publication
(10) Pub. No.: US 2008/0254826 A1
(43) Pub. Date: Oct. 16, 2008

(54) CAPTION DATA TRANSMISSION AND RECEPTION METHOD IN DIGITAL BROADCASTING AND MOBILE TERMINAL USING THE SAME

(75) Inventor: Seong Geun Kwon, Daegu Metropolitan City (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/046,119

(22) Filed: Mar. 11, 2008

(30) Foreign Application Priority Data
Apr. 10, 2007 (KR) 10-2007-0035292

(51) Int. Cl. H04M 1/00; H04N 7/00

(52) U.S. Cl. 455/556.1; 348/468; 348/E07.001

(57) ABSTRACT

The present invention relates to a caption data transmission and reception method in digital broadcasting and to a mobile terminal performing the caption data transmission and reception method. The mobile terminal capable of digital broadcast reception can provide a caption service using Binary Format for Scenes (BIFS) data contained in broadcast data.

### CROSS REFERENCE TO RELATED APPLICATION

This application claims priority from and the benefit of Korean Patent Application No. 10-2007-0035292, filed on Apr. 10, 2007, which is hereby incorporated by reference for all purposes as if fully set forth herein.

### BACKGROUND OF THE INVENTION

1. Field of the Invention

The present invention relates to digital broadcasting and, more particularly, to a caption data transmission and reception method supporting captions in digital broadcasting using Binary Format for Scenes (BIFS), and to a mobile terminal for performing the caption data transmission and reception method.

2. Discussion of the Background

Mobile communication systems provide mobile terminals with various communication services, such as voice communication services, short message services (SMS), multimedia message services (MMS), and moving image mail services. With advances in mobile communication and digital broadcasting technologies, modern mobile terminals are capable of digital broadcast reception and can provide users on the move with digital multimedia broadcasting (DMB) services in addition to standard communication services. In digital broadcasting, a signal carrying multimedia data composed of audio, video, and text may be digitally modulated and provided to fixed, mobile, or in-vehicle terminals.

Although digital broadcasting provides various multimedia signals carrying audio data or video data, text information is not provided for scenes. For example, when a user in motion listens to a music program in digital broadcasting, the user may desire to follow along with and sing the words of a favorite song. However, the user may have difficulty in understanding and following the words of a song in a noisy environment. The user may also experience similar difficulties in receiving news or sports programs. Therefore, it would be advantageous to provide text information to users of mobile terminals during digital broadcast reception.

### SUMMARY OF THE INVENTION

The present invention provides a mobile terminal having a caption capability, and a caption data transmission and reception method in digital broadcasting.

Additional features of the invention will be set forth in the description which follows, and in part will be apparent from the description, or may be learned by practice of the invention.

The present invention discloses a caption data transmission method in digital broadcasting including collecting caption data related to at least one of video data and audio data, generating broadcast data by assembling the caption data together with the at least one of video data and audio data, and transmitting the broadcast data.

The present invention discloses a caption data reception method in digital broadcasting including receiving broadcast data composed of video data, audio data, and caption data, decoding the received broadcast data into the video data, the audio data, and the caption data, creating screen data by assembling the decoded video data and the decoded caption data together, and displaying the screen data while playing back the decoded audio data in a synchronized manner.

The present invention also discloses a caption data transmission and reception method in digital broadcasting including creating caption data related to video data and audio data, generating broadcast data by assembling the video data, the audio data, and the caption data together, transmitting the broadcast data, receiving the broadcast data, decoding the received broadcast data into the video data, the audio data, and the caption data, creating screen data by assembling the decoded video data and the decoded caption data together, and displaying the screen data while playing back the decoded audio data in a synchronized manner.

The present invention also discloses a mobile terminal having a caption capability. The mobile terminal includes a receiving unit, a decoder unit, a compositor unit, and a data play back unit. The receiving unit receives broadcast data composed of video data, audio data, and caption data, and the decoder unit decodes the received broadcast data into video data, audio data, and caption data. The compositor unit assembles the decoded video data and caption data together, and the data play back unit converts the assembled video and caption data into screen data, displays the screen data while playing back the decoded audio data in a synchronized manner.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a caption supporting system according to an exemplary embodiment of the present invention.

FIG. 2 shows a composition of objects related to a screen representation for the system of FIG. 1.

FIG. 3 shows a caption display for the system of FIG. 1 according to an exemplary embodiment of the present invention.

FIG. 4 shows a caption display for the system of FIG. 1 according to another exemplary embodiment of the present invention.

FIG. 5 shows a caption display for the system of FIG. 1 according to another exemplary embodiment of the present invention.

FIG. 6 shows timing relationships between streams transporting broadcast data in the system of FIG. 1.

FIG. 7 shows a configuration of a mobile terminal according to another exemplary embodiment of the present invention.

FIG. 8 shows a configuration of a control unit in the mobile terminal of FIG. 7.

FIG. 9 is a sequence diagram showing a caption support method according to another exemplary embodiment of the present invention.

FIG. 10 is a flow chart showing a caption data receiving procedure in the method of FIG. 9.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Exemplary embodiments of the present invention relate to digital broadcasting including digital multimedia broadcasting (DMB), digital video broadcasting-handheld (DVB-H), and media forward link only (MediaFLO).

Binary Format for Scenes (BIFS) is a special purpose language used to describe captions. The terms ‘BIFS data’ and ‘BIFS caption data’ can be construed to have the same meaning. BIFS data includes a description of audio-visual objects corresponding to audio data and video data constituting a scene, and further includes a description of captions associated with the audio data and video data.

Caption data can be associated with both audio data and brief supplementary descriptions regarding scenes. Thus, BIFS caption data may correspond to video data in the absence of audio data.

For the purpose of description, a mobile communication terminal is described as the mobile terminal of exemplary embodiments of the present invention, however the present invention is not limited to a mobile communication terminal. The mobile terminal may be any terminal capable of digital broadcast reception and may be any information and communication appliance or multimedia appliance, such as a mobile communication terminal, a mobile phone, a digital broadcast receiving terminal, a notebook computer, a personal computer, a personal digital assistant (PDA), a smart phone, an international mobile telecommunications 2000 (IMT 2000) terminal, a wideband code division multiple access (WCDMA) terminal, a universal mobile telecommunications system (UMTS) terminal, or a global system for mobile communications (GSM)/general packet radio services (GPRS) terminal.

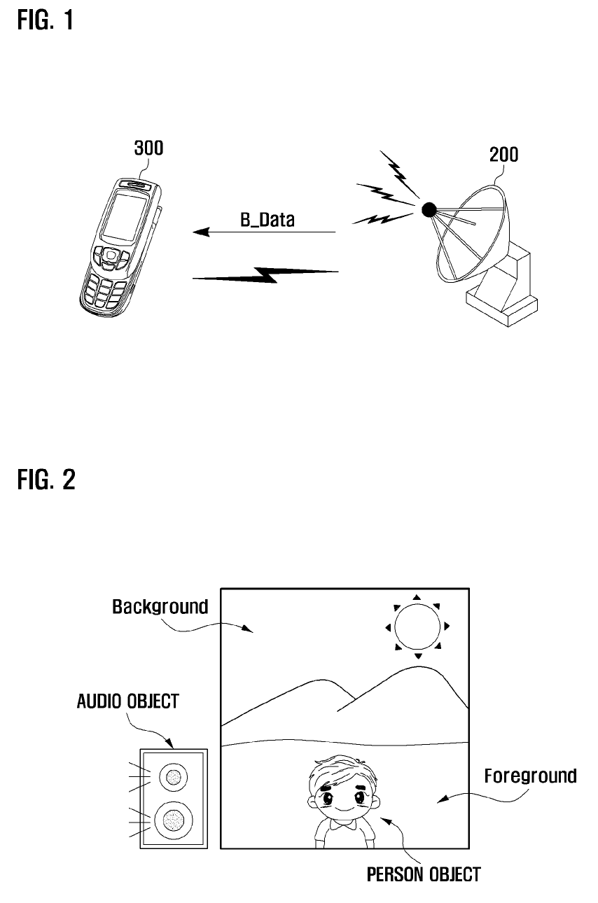

FIG. 1 shows a caption supporting system in digital broadcasting according to an exemplary embodiment of the present invention.

Referring to FIG. 1, the caption supporting system based on digital broadcasting includes a broadcasting center 200 to transmit broadcast data B_Data containing caption data, and a mobile terminal 300 to receive and play back the broadcast data B_Data from the broadcasting center 200. The broadcasting center 200 generates broadcast data B_Data containing caption data and sends the broadcast data B_Data to the mobile terminal 300. Then, the mobile terminal 300 receives the broadcast data B_Data from the broadcasting center 200, extracts video data, audio data, and caption data from the received broadcast data B_Data and decodes and plays back the extracted video data, audio data, and caption data.

For digital broadcasting services, the broadcasting center 200 compresses broadcast data B_Data composed of audio, video, and BIFS data, modulates the compressed broadcast data B_Data into a signal, and transmits the modulated signal. The broadcasting center 200 may provide broadcast data B_Data through artificial satellites of a satellite DMB system or through base stations of a terrestrial DMB, DVB-H, or MediaFLO system to the mobile terminal 300.

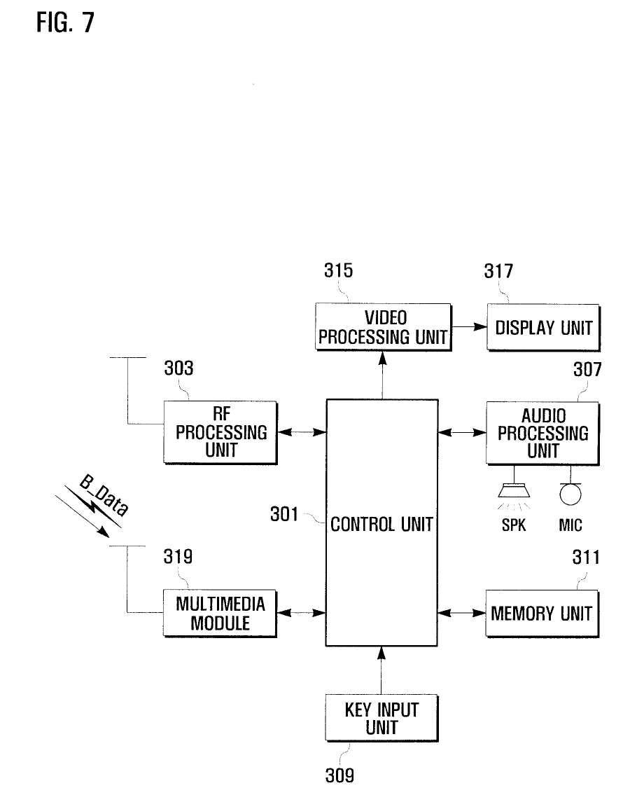

The mobile terminal 300 receives broadcast data B_Data from the broadcasting center 200 and decodes the received broadcast data B_Data into video data, audio data, and BIFS data. The mobile terminal 300 combines the video data and BIFS data together to form screen data. The mobile terminal 300 outputs the screen data and audio data to a display unit and speaker, respectively, for synchronized play back. The mobile terminal 300 is described below in connection with FIG. 7.

Next, broadcast data B_Data containing caption data is described in detail.

FIG. 2 shows a composition of objects related to a screen representation.

Referring to FIG. 2, screen-related elements of broadcast data B_Data can be divided into visual objects and audio objects. For example, the broadcast data B_Data in FIG. 2 can be separated into visual objects in the screen and audio objects played back in a manner synchronized with the visual objects. The visual objects in the screen can include background objects such as foreground images and background images, and independent objects such as humans, cars, animals, and the like. Screen-related elements can be described in languages, such as the extensible markup language (XML), the virtual reality modeling language (VRML), and BIFS. In the description, BIFS is used. BIFS describes a scene as a composition of objects in a text form. That is, BIFS describes the colors, the positions, and the sizes of individual background objects and independent objects. BIFS data is transmitted in a streaming manner. BIFS data includes BIFS configuration information and BIFS commands. The BIFS configuration information includes decoder specific information, such as the horizontal and vertical dimensions of the scene. The BIFS commands are described in the form of a string and are used to modify properties of the scene at a given point in time.

In exemplary embodiments of the present invention, BIFS data includes caption data. That is, BIFS commands include a caption string to be displayed in a caption area and information regarding the colors, the sustenance duration, and the deletion timing of the caption.

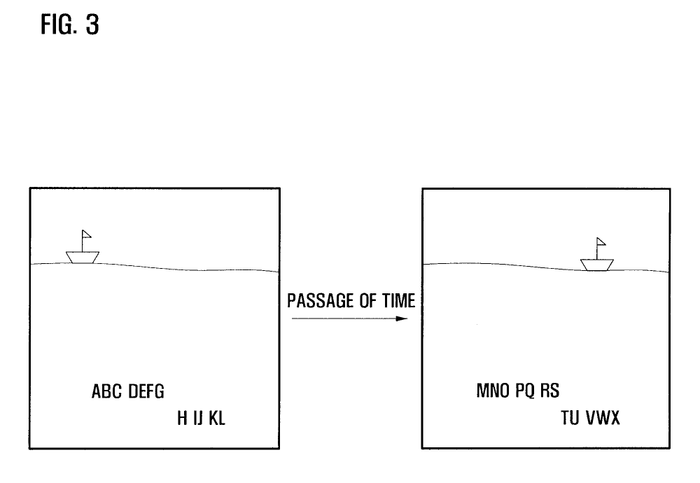

FIG. 3 shows a caption display according to an exemplary embodiment of the present invention. The screen is generated from broadcast data B_Data described in BIFS, and the broadcast data B_Data includes BIFS data, which contains caption data.

Referring to FIG. 3, a caption is displayed in a caption area below the area in which video data is displayed. The caption can be maintained at the same location while the video data on the display changes. Therefore, the caption data should include a caption sustenance duration indicating the period during which the caption is to be displayed. The caption sustenance duration can be an absolute time from the start of caption display or a start time and stop time that are synchronized with the video data. When a caption sustenance duration is an absolute time, BIFS data can include independent caption data that is not synchronized with the video data. The caption data in BIFS data may be synchronized with the audio data. That is, the caption may be displayed for a duration corresponding to the audio data and may then be removed or changed to another caption.

Referring to FIG. 3, a caption is displayed for a preset duration on a portion of the screen and then removed. That is, a caption is displayed for a preset duration at a location below the area on which video data is displayed and then the caption is removed. Another caption is displayed in the same area and in the same manner as before. The caption may be a text version of audio data being played back or a text version of audio data synchronized with images of video data. That is, the caption may provide the user of a mobile terminal with text information corresponding to the video data or the audio data. The caption should be displayed as a text expression finely synchronized with the video data or the audio data. In some situations, a caption may be displayed in advance of the corresponding the audio data. Captions may be edited and manipulated by the broadcasting center 200 creating the broadcast data B_Data. For example, points in time of caption display may be adjusted by the user of the mobile terminal.

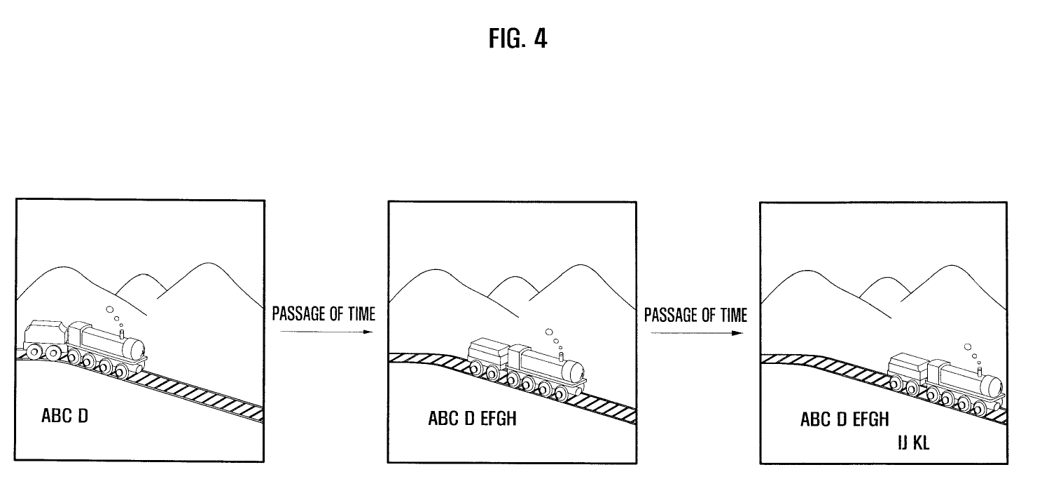

FIG. 4 shows a caption display according to another exemplary embodiment of the present invention.

Referring to FIG. 4, portions of a caption may be displayed in a stepwise manner on a screen. For example, the beginning of a caption (i.e. “ABC D”) may be displayed initially. After the passage of time, another portion of the caption may be displayed in addition to the initial portion (i.e. “ABC D EFGH”). After the passage of more time, the entire caption may be displayed (i.e. “ABC D EFGH IJ KL”).

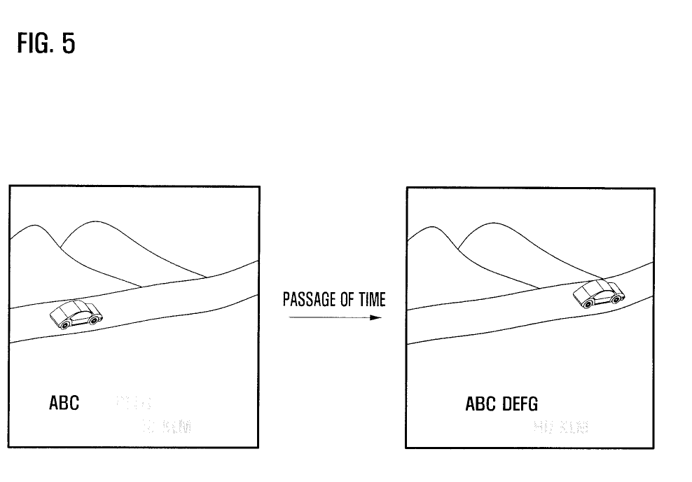

FIG. 5 shows a caption display according to another exemplary embodiment of the present invention.

Referring to FIG. 5, a caption displayed on a screen may change, for example, change color, in a stepwise manner with the passage of time. That is, a caption that is to be sustained for a preset duration is displayed on a portion below the area in which video data is displayed. Then, portions of the caption may be changed in sequence in a manner indicating the passage of time. For example, when a caption of a preset color is displayed on the screen, the color(s) of portions of the caption may change with the passage of time. For example, “ABC” may initially be displayed in white, while the rest of the caption is displayed in black. Then after the passage of time, “DEFG” may change from black to white. Thus, a caption that changes in color may provide a viewer or listener with direct and real-time synchronization of video data and audio data.

Hereinabove, the caption supporting system and caption display are described. Next, transmission of broadcast data B_Data containing caption data is described.

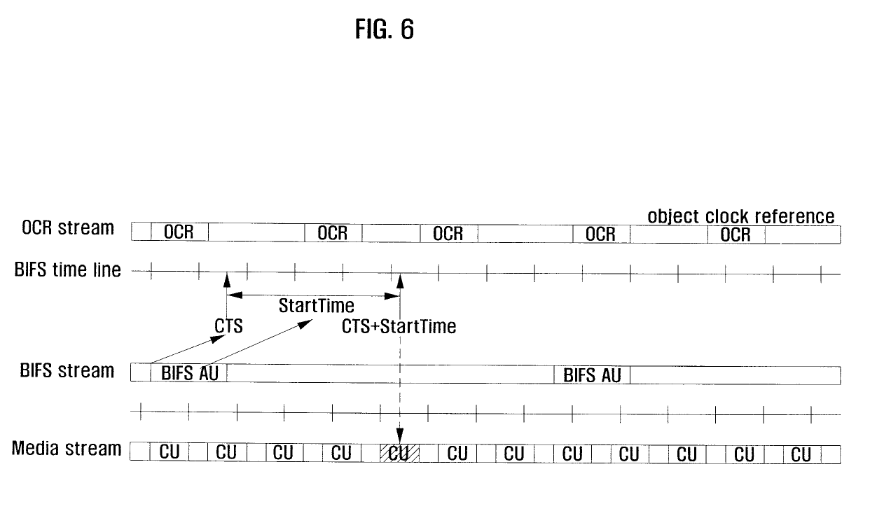

FIG. 6 shows timing relationships between streams transporting broadcast data.

The timing diagram of FIG. 6 shows timing relationships between an object clock reference (OCR) stream, a BIFS stream, and a media stream. The OCR is a clock reference that is used by a decoder for the media stream. The timing diagram further includes a BIFS time line for play back timing of the BIFS stream. The media stream may include at least one of video data and audio data, and may be, in particular, an audio stream of a music program.

The OCR is a clock reference for an object, and provides a reference time for all component data in broadcast data B_Data. That is, the OCR provides a timing reference to receive and play back information contained in the media stream of audio or video data, and information in the BIFS stream.

The BIFS stream includes BIFS access units (AU) at regular intervals in accordance with the clock reference of the OCR stream. The access units are individually accessible portions of data within a stream and are the smallest data entities to which timing information can be attributed. The mobile terminal 300 uses BIFS access units to determine the timing to decode BIFS data of received broadcast data B_Data.

The media stream includes composition units (CU), which are individually accessible portions of the output that a decoder produces from access units. The composition units indicate whether video data or audio data of a broadcast service is usable in the mobile terminal 300. The composition units are played back by the mobile terminal 300 together with caption data in BIFS data.

The BIFS time line indicates the timing to display caption data contained in BIFS data. A composition time stamp (CTS) indicates the nominal composition time of a composition unit. The composition time indicates the point in time at which data in a BIFS access unit should become valid. In FIG. 6, a BIFS access unit has a timestamp CTS and a decoding time StartTime. Hence, the caption data contained in the BIFS access unit may be synchronized with a corresponding composition unit (gray-colored), which will be played back after the decoding time StartTime.

As described above, the mobile terminal 300 receives an OCR stream, a BIFS stream, and a media stream from the broadcasting center 200, obtains media stream data with reference to the OCR of the OCR stream, and plays back caption data contained in the BIFS stream in a synchronized manner with the media stream data with reference to the OCR.

Hereinabove, the structure of BIFS data and transmission of broadcast data B_Data are described. Next, a mobile terminal having a caption capability using BIFS data is described.

FIG. 7 shows a configuration of a mobile terminal 300 according to another exemplary embodiment of the present invention.

Referring to FIG. 7, the mobile terminal 300 includes a multimedia module 319, a control unit 301, an audio processing unit 307, a key input unit 309, a memory unit 311, a video processing unit 315, and a display unit 317. The mobile terminal 300 may further include a radio frequency (RF) processing unit 303 to perform mobile communication operations.

The multimedia module 319 recognizes a digital broadcasting system, such as satellite DMB, terrestrial DMB, DVB-H, or MediaFLO, requested by the user and provides video, audio, and text broadcast services through the recognized digital broadcasting system. The multimedia module 319 sends user data or applications related (or mapped) to the broadcast services through the control unit 301 to one or both of the video processing unit 315 and audio processing unit 307.

In particular, the multimedia module 319 receives broadcast data B_Data from the broadcasting center 200. When the broadcast data B_Data is broadcast through a satellite DMB system, the multimedia module 319 acts as a satellite DMB receiving module. When the broadcast data B_Data is broadcast through a terrestrial DMB system, the multimedia module 319 acts as a terrestrial DMB receiving module. When the broadcast data B_Data is broadcast through a DVB-H system, the multimedia module 319 acts as a DVB-H receiving module. When the broadcast data B_Data is broadcast through a MediaFLO system, the multimedia module 319 acts as a MediaFLO receiving module. That is, the multimedia module 319 is a broadcast receiving module that can receive broadcast data B_Data through any digital broadcasting systems. The multimedia module 319 may include a radio frequency module and a baseband chip to receive broadcast data B_Data.

The control unit 301 controls the overall operation of the mobile terminal 300. For example, the control unit 301 controls signal exchange between internal elements including the multimedia module 319, the key input unit 309, the memory unit 311, and the video processing unit 315. The control unit 301 sets and switches operating modes in response to a mode change signal from the key input unit 309. For example, the control unit 301 controls transitions between a phone mode for mobile communication service and a multimedia mode for digital broadcast service. The control unit 301 also controls the display of user data created or maintained by supplementary functions related to operating mode switching.

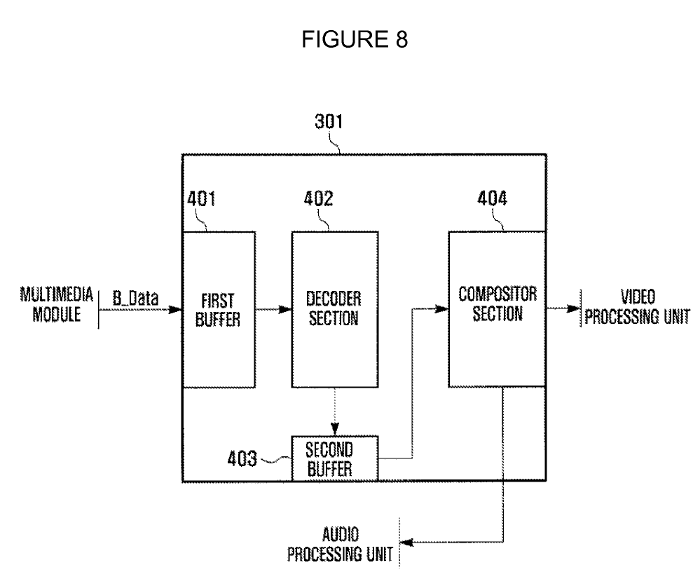

In particular, the control unit 301 decodes broadcast data B_Data received through the multimedia module 319, assembles decoded data, and sends the assembled data to the video processing unit 315 and the audio processing unit 307. Therefore, as shown in FIG. 8, the control unit 301 may include a first buffer 401, a decoder section 402, a second buffer 403, and a compositor section 404.

The first buffer 401 is a buffer that temporarily stores received broadcast data B_Data from the multimedia module 319. That is, the first buffer 401 is a decoding buffer that temporarily stores the received broadcast data B_Data before decoding by the decoder section 402. In consideration of broadcast data having various data types, the first buffer 401 can classify and store portions of received broadcast data B_Data according to their data types such as video, audio, and others.

The decoder section 402 includes at least one decoder to decode broadcast data B_Data stored in the first buffer 401. For example, when the broadcast data B_Data contains video data, audio data, and BIFS data, the decoder section 402 may include a video decoder to decode video data, an audio decoder to decode audio data, and a BIFS decoder to decode BIFS data. The decoder section 402 decodes portions of broadcast data B_Data according to their data types, and sends the decoded broadcast data B_Data to the second buffer 403. If broadcast data B_Data from the first buffer 401 is unclassified, the decoder section 402 can perform a demultiplexing operation to classify the broadcast data B_Data according to data types. For BIFS data, as shown in the timing diagram of FIG. 6, the decoder section 402 may decode the BIFS data so that the BIFS data is synchronized with corresponding media stream data with reference to the OCR. That is, the decoder section 402 decodes the BIFS data in consideration of composition time stamps and start times.

The second buffer 403 separately stores video data, audio data, and BIFS data from the decoder section 402, and sends the stored video data, audio data, and BIFS data to the compositor section 404.

The compositor section 404 assembles video data and BIFS data from the second buffer 403 together. That is, the compositor section 404 synchronizes the video data and caption data in the BIFS data and sends the synchronized video data and caption data to the video processing unit 315. The compositor section 404 also sends audio data to be synchronized with the video data to the audio processing unit 307. Thus, the compositor section 404 can send the synchronized video data and caption data through the video processing unit 315 to the display unit 317 and also can send audio data synchronized with the video data and caption data to the audio processing unit 307.

Referring back to FIG. 7, the audio processing unit 307 plays back audio data from the multimedia module 319 through a speaker SPK, and sends an audio signal, such as a voice signal, from a microphone MIC to the control unit 301. In particular, the control unit 301 controls the audio processing unit 307 to play back audio data in a synchronized manner with video data and caption data of BIFS data.

The key input unit 309 includes a plurality of alphanumeric and function keys to input alphanumeric information and to set various functions. In particular, the key input unit 309 generates a key signal for a digital broadcast service provided through the multimedia module 319. The key input unit 309 generates a key signal to receive a caption service during digital broadcast reception. The key input unit 309 can generate a key signal through selection of a menu item or a hot key. The key input unit 309 generates a key signal to select a caption service in response to a selection of the user and sends the generated key signal to the control unit 301.

The memory unit 311 may include a program memory section to store programs to provide digital broadcast reception services, and a data memory section to store data generated from the execution of the programs. The program memory section stores programs to control the operations of the mobile terminal 300, programs to provide digital broadcast reception services, and decoding modules to decode broadcast data B_Data. The data memory section stores pieces of data generated from execution of the programs, setting information for digital broadcast reception services, user setting information for the present exemplary embodiment, and a database to store various data and menu-related data in a classified form. The memory unit 311 may allocate storage spaces to the first buffer 401 and second buffer 403 of the control unit 301.

The video processing unit 315 converts data from the control unit 301 into a visual signal, generates screen data corresponding to the visual signal, and sends the generated screen data to the display unit 317. The control unit 301 controls the video processing unit 315 to convert assembled video data and BIFS caption data into screen data and sends the screen data to the display unit 317. The video processing unit 315 controls the position, the size, and the color of a caption on the display unit 317 using BIFS data.

For caption display, the video processing unit 315 can display a caption at a portion below the area of the screen of the display unit 317 at which video data is displayed. The video processing unit 315 may sustain the caption for a preset duration or may change portions of the caption in a preset duration. For example, when caption data includes words of a song, a corresponding caption may include one or more phrases of the song. Selected phrases may be displayed in an area of the screen as one or two lines for a preset duration, and then may be replaced with next phrases. Phrases may be displayed in a stepwise manner for a preset duration until they are fully displayed, and then may be replaced with next phrases. The video processing unit 315 may change colors of portions of a caption with the passage of time. For example, when a caption of song phrases is fully displayed on the screen, the colors of the individual phrases can be changed in a stepwise manner with the passage of time and/or the colors of the entire caption can be changed after a certain time. The video processing unit 315 may display captions in other manners such as an up-down or left-right sliding manner.

The display unit 317 displays visual data from the video processing unit 315. The display unit 317 displays windows to execute applications to provide digital broadcast reception services. The display unit 317 displays video data and BIFS caption data of a selected audio and video channel on the screen under the control of the control unit 301. The display unit 317 displays a channel selection window to select broadcast data B_Data received through the multimedia module 319. The display unit 317 may display a caption of BIFS data together with video data in an overlapping manner.

The RF processing unit 303 performs communication operations related to voice communication, short message services (SMS), multimedia message services (MMS), and data communication. The RF processing unit 303 includes an RF transmitter to upconvert the frequency of a signal to be transmitted and amplify the signal, and an RF receiver to low-noise amplify a received signal and downconvert the frequency of the received signal. If the mobile terminal 300 is a mobile communication terminal, the RF processing unit 303 may establish a communication channel with a mobile communication system and send and receive a voice call or data to and from another mobile terminal through the communication channel.

Hereinabove, the mobile terminal having a caption capability is described. Next, a caption support method is described.

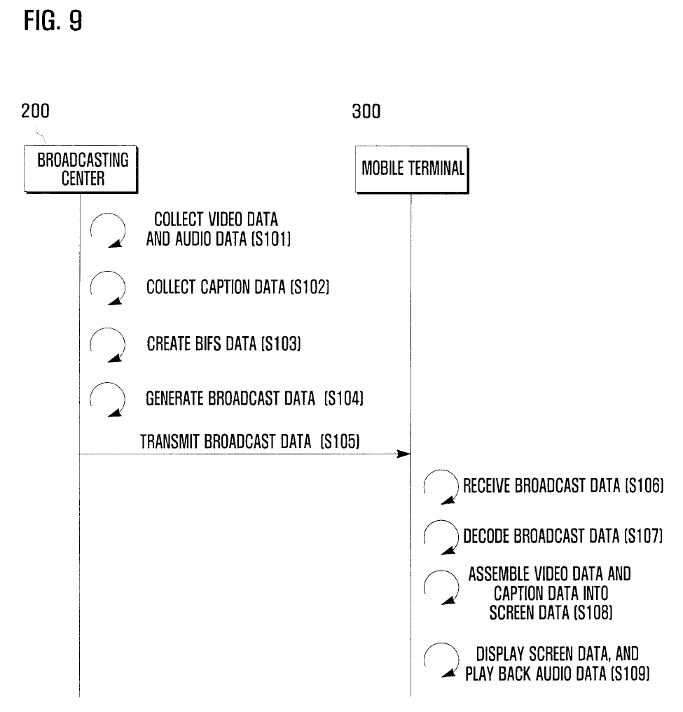

FIG. 9 is a sequence diagram showing a caption support method according to another exemplary embodiment of the present invention.

Referring to FIG. 9, the broadcasting center 200 collects video data and audio data (S101) and collects caption data on the basis of the video data and the audio data (S102). The broadcasting center 200 creates caption data synchronized with the video data and the audio data. Thereafter, the broadcasting center 200 creates BIFS caption data corresponding to the video data and the audio data (S103) and combines the BIFS caption data, the video data, and the audio data together into broadcast data B_Data according to a preset specification (S104). That is, the broadcasting center 200 encodes video data, audio data, and associated caption data in accordance with a preset specification, such as the MPEG-4 specification.

According to the MPEG-4 specification, the broadcasting center 200 creates a program association table (PAT) having three program map tables (PMT). A PMT lists related streams of audio data, BIFS data, and video data. For example, a first PMT contains information regarding first audio data and BIFS data, a second PMT contains information regarding second audio data and first video data, and a third PMT contains information regarding third audio data and second video data. A PMT contains a packet identifier (PID) of each data stream. Hence, the mobile terminal 300 can obtain desired video data, audio data, and BIFS data by checking a corresponding PMT via the PAT. Data is divided into transport stream packets, which are then transmitted. The header part of a transport stream packet includes a PID and an object clock reference (OCR). The OCR is used as a clock reference for playback of data in the payload part of the transport stream packet. Broadcast data (one of video data, audio data and BIFS data) is stored in the payload parts of transport stream packets. The broadcast data, video data, and audio data may be stream types, and the BIFS data may be a string type.

Thereafter, the broadcasting center 200 transmits the broadcast data B_Data to the mobile terminal 300 (S105).

The mobile terminal 300 receives the broadcast data B_Data from the broadcasting center 200 (S106). The mobile terminal 300 can activate the multimedia module 319 in response to a key signal by the user for digital broadcast reception, and receive the broadcast data B_Data.

The mobile terminal 300 decodes the received broadcast data B_Data under the control of the control unit 301 (S107). The control unit 301 includes a video decoder, an audio decoder, and a BIFS decoder and decodes the broadcast data B_Data into video data, audio data, and BIFS data using the corresponding decoders.

The mobile terminal 300 combines the video data and the caption data of the BIFS data together into screen data (S108) and displays the screen data on the display unit 317 while playing back the audio data through the audio processing unit 307 (S109).

As described above, the caption support method creates caption data to be synchronized with at least one of video data and audio data, and inserts the created caption data to BIFS data describing the video data and audio data as objects. The caption support method transmits broadcast data B_Data containing the BIFS data to the mobile terminal 300. The mobile terminal 300 includes a separate decoder for BIFS data, extracts caption data from the BIFS data, and plays back the caption data on the display unit 317 in a manner synchronized with the video data and/or audio data. Accordingly, the caption support method can provide a caption capability by transmitting and receiving BIFS data containing caption data without the use of a separate channel for caption data transmission, wherein the BIFS data describes video data and audio data for digital broadcasting.

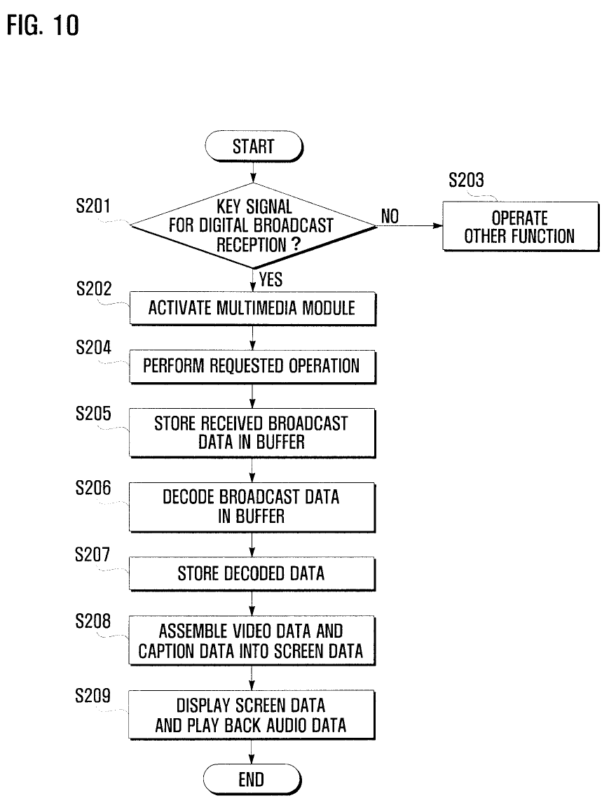

FIG. 10 is a flow chart showing a caption data receiving procedure in the caption support method of FIG. 9. The caption data receiving procedure is performed by the mobile terminal 300.

Referring to FIG. 10, the control unit 301 of the mobile terminal 300 checks whether an input key signal is for digital broadcast reception (S201).

If the input key signal is not for digital broadcast reception, the control unit 301 controls corresponding elements to perform an operation requested by the input key signal, such as phone call processing, photographing, or MP3 file playing (S203).

If the input key signal is for digital broadcast reception, the control unit 301 activates the multimedia module 319 (S202). The control unit 301 enables the caption function by default upon activation of the multimedia module 319. The caption function may be enabled or disabled according to a selection by the user. When the caption function is disabled, the control unit 301 controls an operation to ignore caption data of BIFS data in broadcast data B_Data instead of displaying the caption data. The caption function may be enabled or disabled through the key input unit 309 before or during digital broadcast reception.

The control unit 301 controls the multimedia module 319 to receive broadcast data B_Data from the broadcasting center 200 (S204). The control unit 301 stores the received broadcast data B_Data in the buffer (S205) and decodes the broadcast data B_Data in the buffer (S206).

The control unit 301 may separate the received broadcast data B_Data according to component data types into video data, audio data, and BIFS data, which are then stored in the buffer (S205). Then, the control unit 301 may decode each component data separately (S206). Therefore, the control unit 301 may include a video decoder, an audio decoder, and a BIFS decoder to separately decode each component data.

The control unit 301 stores decoded data in another buffer (S207), and assembles the video data and BIFS data together into screen data (S208). The control unit 301 may separately store the video data, the audio data, and the BIFS data in the buffer (S207). Then, the control unit 301 creates the screen data by assembling the video data and BIFS caption data together (S208). The screen data contains caption data. When the screen data is played back, the caption data may be displayed on a portion of the screen of the display unit 317 together with the video data.

The control unit 301 controls the display unit 317 to display the screen data, and also controls the audio processing unit 307 to play back the audio data in a synchronized manner with the screen data (S209).

In step S209, the control unit 301 may control the caption display operation in various manners according to selection of detailed options through menus and key signals. For example, the control unit 301 may control the caption display operation so that a caption is fully displayed at once, sustained for a preset duration, and then replaced with another caption. The control unit 301 can control the caption display operation so that portions of a caption are displayed in a stepwise manner for a preset duration until the caption is fully displayed and then the caption is replaced with a next caption. The next caption may be displayed in the same manner as the previous caption. The control unit 301 may control the caption display operation so that a caption is fully displayed at once and sustained for a preset duration, and then colors of portions of the caption are changed over time. The control unit 301 may control the caption display operation in other manners such as an up-down or left-right sliding manner.

As apparent from the above description, exemplary embodiments of the present invention provide a system, a method, and a mobile terminal that support captions in digital broadcast reception services. A separate channel for caption data transmission is not required. Broadcast data contains BIFS data, which contains caption data. As a result, caption data is contained in the broadcast data itself, which may provide economic and effective caption services in digital broadcasting.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A caption data transmission method in digital broadcasting, comprising:
collecting caption data related to video data;
generating broadcast data by assembling the caption data together with the at least one of video data and audio data; and
transmitting the broadcast data.

2. The caption data transmission method of claim 1, wherein the caption data is contained in binary format for scenes (BIFS) data that describes scenes of the at least one of video data and audio data as objects and includes information regarding colors, sustenance duration, and deletion timing of the caption

3. The caption data transmission method of claim 2, wherein generating broadcast data comprises:
creating a media stream containing the at least one of video data and audio data;
creating a BIFS stream according to transmission of the BIFS data; and
creating a object clock reference (OCR) stream defining a clock reference to play back at least one of the video data and audio data and the BIFS data.

4. The caption data transmission method of claim 3, wherein creating a BIFS stream comprises synchronizing the BIFS stream and the media stream.

5. A caption data reception method in digital broadcasting, comprising:
receiving broadcast data composed of video data, audio data, and caption data;
decoding the received broadcast data into the video data, the audio data, and the caption data;
creating screen data by assembling the decoded video data and the decoded caption data together;
displaying the screen data while playing back the decoded audio data in a synchronized manner, and wherein the caption data includes captions corresponding to the video data.

6. The caption data reception method of claim 5, wherein the caption data is contained in binary format for scenes (BIFS) data that describes scenes of the video data and audio data as objects.

7. The caption data reception method of claim 6, further comprising separating the broadcast data into the video data, the audio data, and the BIFS data.

8. The caption data reception method of claim 7, wherein decoding the received broadcast data comprises:
decoding the video data;
decoding the audio data; and
decoding the BIFS data.

9. The caption data reception method of claim 8, wherein displaying the created screen data comprises displaying the caption data on a portion of a screen together with the video data in an overlapping manner.

10. The caption data reception method of claim 9, wherein displaying the caption data comprises one of:
displaying a caption fully at once, sustaining the caption, and then replacing the caption with another caption;
displaying portions of a caption in a stepwise manner until the caption is fully displayed and then replacing the caption with another caption;
displaying a caption fully at once, sustaining the caption, and changing colors of portions of the caption over time; and
displaying portions of a caption in a stepwise manner while sliding the caption in a left-right or up-down direction of the screen.

11. The caption data reception method of claim 9, wherein displaying the caption data comprises displaying the caption data while playing back at least one of the video data and the audio data.

12. A caption data transmission and reception method in digital broadcasting, comprising: creating caption data related to video data;
generating broadcast data by assembling the video data, the audio data, and the caption data together;
transmitting the broadcast data;
receiving the broadcast data;
decoding the received broadcast data into the video data, the audio data, and the caption data;
creating screen data by assembling the decoded video data and the decoded caption data together; and
displaying the screen data while playing back the decoded audio data in a synchronized manner.

13. The caption data transmission and reception method of claim 12, wherein the caption data is contained in binary format for scenes (BIFS) data that describes scenes of the video data and audio data as objects, and includes information regarding colors, sustenance duration, and deletion timing of the caption.

14. The caption data transmission and reception method of claim 13, further comprising separating the received broadcast data into the video data, the audio data, and the BIFS data.

15. The caption data transmission and reception method of claim 14, wherein displaying the created screen data comprises displaying the caption data while playing back at least one of the video data and the audio data.

16. A mobile terminal having a caption capability, comprising:
a receiving unit to receive broadcast data composed of video data, audio data, and caption data;
a decoder unit to decode the received broadcast data into the video data, the audio data, and the caption data;
a compositor unit to assemble the decoded video data and the decoded caption data together; and
a data play back unit to convert the assembled video and caption data into screen data, to display the screen data while playing back the decoded audio data in a synchronized manner, and wherein the caption data includes captions corresponding to the video data.

17. The mobile terminal of claim 16, wherein the caption data is contained in binary format for scenes (BIFS) data that describes scenes of the video data and audio data as objects and includes information regarding colors, sustenance duration, and deletion timing of the caption.

18. The mobile terminal of claim 17, further comprising a memory unit to store the broadcast data, which is separated into the video data, the audio data, and the BIFS data.

19. The mobile terminal of claim 17, wherein the decoder unit comprises:
a video decoder to decode the video data;
an audio decoder to decode the audio data; and
a BIFS decoder to decode the BIFS data.

20. The mobile terminal of claim 16, wherein the data play back unit comprises:
a display unit to display the screen data; and
an audio processing unit to play back the decoded audio data in a synchronized manner.

21. The mobile terminal of claim 20, wherein the display unit displays the caption data on a portion of a screen together with the video data in an overlapping manner.

22. The mobile terminal of claim 20, wherein the display unit:
displays a caption fully at once, sustains the caption, and then replaces the caption with another caption;
displays portions of a caption in a stepwise manner until the caption is fully displayed, and then replaces the caption with another caption;
displays a caption fully at once, sustains the caption, and changes colors of portions of the caption over time; or
displays portions of a caption in a stepwise manner while sliding the caption in a left-right or up-down direction of the screen.

23. The mobile terminal of claim 20, wherein the display unit displays the caption data while playing back at least one of the video data and the audio data.
